(19) United States
(12) Patent Application Publication
(10) Pub. No.: US 2026/0086573 A1
(43) Pub. Date: Mar. 26, 2026

(54) METHOD AND SYSTEM FOR CONTROLLING MOVEMENT OF AN AUTONOMOUS LOAD-CARRIER VEHICLE

(71) Applicant: Volvo Autonomous Solutions AB, Göteborg (SE)

(72) Inventors: Oskar NORESSON, Göteborg (SE); Åsa ROGENFELT, Göteborg (SE); Gustaf JOHANSSON, Göteborg (SE)

(73) Assignee: Volvo Autonomous Solutions AB, Göteborg (SE)

(21) Appl. No.: 19/111,127

(22) PCT Filed: Sep. 21, 2022
(86) PCT No.: PCT/EP2022/076273

§ 371 Date: Mar. 12, 2025

(51) Int. Cl. G05D 1/667; E02F 9/20; G05D 105/28; G05D 107/90

(52) U.S. Cl. CPC G05D 1/667; E02F 9/2025; G05D 2105/28; G05D 2107/90

(57) ABSTRACT

A method includes providing, from a positioning sensor on a loader vehicle for loading the autonomous load-carrier vehicle, a control signal indicative of a current position of the loader vehicle; determining a point on the pre-set path closest to the current position of the loader vehicle; setting a loading position for the autonomous load-carrier vehicle at a point along the pre-set path based on the point on the pre-set path that is closest to the current position of the loader vehicle; wherein the suitable loading position corresponds to the point closest to the current position of the loader vehicle or is a point in the immediate surroundings of the closest point so as to, when the autonomous load-carrier vehicle stops at the suitable loading position, allow pre-set aligning of a part of the autonomous load-carrier vehicle in relation to the loader vehicle when the loader vehicle is positioned close to the pre-set path; and controlling the autonomous load-carrier vehicle to move along the pre-set path and stop at the suitable loading position.

### TECHNICAL FIELD

The invention relates to a method and system for controlling movement of an autonomous load-carrier vehicle along a pre-set path at a construction site. In particular, the method and system relates to setting a suitable loading position for the autonomous load-carrier.

### BACKGROUND

There is an increasing interest in using autonomous load-carrier vehicles (AVs) in confined areas, such as using autonomous trucks or haulers at large construction sites. A load carrier AV used in an application of this type typically follows a pre-set loop-type path/route and stops at a loading position where it is loaded by e.g. a wheel loader, sets off in the same direction along its path after loading towards some unloading position, and continues along its path to the same or another loading position. Since load piles at large construction sites typically are subject to change in both position and size, there is a challenge in such applications to set a proper loading position for the AV, i.e. a pre-set loading position is not likely to be suitable when the load pile has decreased in size or when material from another load pile is to be loaded onto the AV.

CN114326738A addresses a similar problem but for mine unmanned transport vehicles that drive back and forth along pre-set transport routes to and from loading area positions. A target loading area is selected from two or more candidate loading area positions depending on a relative relationship in distance or direction between the working position of the excavating equipment and each candidate loading area position. This might be a useful method for mine applications where the unmanned transport vehicle drives back and forth, but it is not suitable for constructions sites where an autonomous vehicle is intended to drive along the pre-set path and continue in the same direction after loading and where there are no particular candidate loading area positions to select between and the challenge instead is to find an arbitrary loading position.

### SUMMARY

An object of the invention is to provide a method and system for controlling movement of an autonomous load-carrier vehicle along a pre-set path at a construction site, which method/system allows for setting a suitable loading position for the autonomous load-carrier vehicle.

The method comprises:
providing, from a positioning sensor arranged onto a loader vehicle intended to be used for loading the autonomous load-carrier, a control signal indicative of a current position of the loader vehicle;
determining a point on the pre-set path that is closest to the current position of the loader vehicle;
setting a suitable loading position for the autonomous load-carrier vehicle along the pre-set path based on the point on the pre-set path that is closest to the current position of the loader vehicle; wherein the suitable loading position corresponds to the point closest to the current position of the loader vehicle or is a point in the immediate surroundings of said closest point so as to, when the autonomous load-carrier vehicle stops at the suitable loading position, allow pre-set aligning of a part of the autonomous load-carrier vehicle in relation to the loader vehicle when the loader vehicle is positioned close to the pre-set path; and
controlling the autonomous load-carrier vehicle so as to move along the pre-set path and stop at the suitable loading position.

The term pre-set path means a predefined or pre-recorded plurality of position data forming a path, typically in the form of some closed loop, that the autonomous load-carrier vehicle is intended to follow at the construction site.

The suitable loading position may correspond exactly to the point on the pre-set path that is closest to the current position of the wheel loader. However, the suitable loading position may alternatively be set at a point in the immediate surroundings of, or proximate to, the point closest to the current position of the wheel loader. On a large scale the difference between these alternatives may be seen as insignificant, e.g. if the autonomous load-carrier vehicle has to move hundreds or thousands of meter to come close to a loader vehicle located close to the pre-set path it may be considered to be insignificant whether the autonomous load-carrier vehicle stops exactly at a point of the path being closest to (the positioning sensor of) the loader vehicle or if it stops a few meters away from that point. However, on a small scale, a meter scale, a variant of the invention may include setting the suitable loading point on a detailed level so that a load carrying compartment of the autonomous load-carrier is aligned with a bucket of the loader vehicle (to avoid aligning e.g. a cab of the autonomous load-carrier with the bucket). A positive or negative offset could thus be included when setting the suitable loading position so that the suitable loading position becomes located some meters away from the point on the pre-set path that is closest to the current position of the wheel loader, i.e. in the immediate surroundings of said closest point. Such detailed setting of the suitable loading point may not be necessary but if included it will most likely require consideration of the exact position of the position sensors arranged on the vehicles since it makes a difference on this detailed scale if a position sensor is mounted at a front or back of a vehicle.

By using a GPS or another positioning sensor on a wheel loader or other loader vehicle, the loader vehicle operator does not need to explicitly specify a loading position for the vehicle to be loaded. Instead, the autonomous load-carrier vehicle can be controlled to automatically stop at the point on the path closest to wheel loader (or a point close thereto as explained above) when being called to the loading spot. This decreases the distance the loader vehicle has to move for performing the loading operation.

As an example, using an HMI (Human-Machine Interface) for communication with the autonomous vehicles (AVs), a wheel loader operator may:
1. Call forth an autonomous vehicle for loading. The AV will then travel to the point along its pre-recorded path that is closest to the wheel loader, i.e. to the suitable loading position. If the wheel loader moves, the AV will respond accordingly.
2. Lock the loading position of the autonomous vehicle. This will trigger a sequence of events inside the AV and make it ready to accept load. The AV will not follow the wheel loader when the loading position has been locked.
3. Send away the autonomous vehicle for unloading (along the pre-set path in the same direction as it moved before being loaded).

Load requests and (GPS) positioning data may be sent from the loader vehicle to an offboard logic module/control system that may be cloud-based or situated on premise. The data is then processed and forwarded to the autonomous vehicle. Also the autonomous load-carrier vehicle is provided with a positioning sensor and it is preferably configured to constantly sending feedback of its status and position so as to keep the logic module/control system updated. The control system is also configured to control the autonomous load-carrier vehicle (movement along its path, status, activity, etc.), determine the point on the pre-set path that is closest to the current position of the loader vehicle, etc.

In an embodiment, the step of determining the point on the pre-set path that is closest to the current position of the loader vehicle comprises: searching for points defining the pre-set path, wherein the search is carried out along a first circle around the loader vehicle; if no path-defining points are found along the first circle: searching for path-defining points along a second circle that is larger than the first circle; if a plurality of path-defining points are found along the first circle: searching for path-defining points along a third circle that is smaller than the first circle.

The circles are centered around the loader vehicle. Typically, smaller and/or larger circles are tested in a step-wise manner until only one path-defining point is found along the circle; that point can then be considered to form the point on the pre-set path that is closest to the current position of the loader vehicle. The test may also be stopped when two points have been found that are located within a threshold distance from each other.

There are other ways of finding the point on the pre-set path that is closest to the current position of the loader vehicle, such as various variants of nearest neighbor search (NNS).

In an embodiment, the method comprises: locking the suitable loading position for the autonomous load-carrier vehicle so that it no longer follows the position of the loader vehicle. The suitable loading position will then be associated with the position of the loader vehicle when locking the suitable loading position.

In an embodiment, the method comprises: starting the autonomous load-carrier vehicle after loading by the loader vehicle and moving the autonomous load-carrier vehicle along the pre-set path in the same direction as it moved before stopping at the suitable loading position. The autonomous load-carrier vehicle can thereby continue in a forward (or backwards) direction of the pre-set path towards an unloading location and avoid interfering with a further autonomous load-carrier vehicle approaching the loading location.

In an embodiment, the method comprises: providing a control signal indicative of a request for the autonomous load-carrier vehicle to be loaded by the loader vehicle.

In an embodiment, the method comprises: repeating the steps of i) providing the control signal indicative of the current position of the loader vehicle, ii) determining the point closest to the current position of the wheel loader and iii) setting the suitable loading position for the autonomous load-carrier vehicle, so as to update the suitable loading position when the loader vehicle moves.

In an embodiment, the immediate surroundings of the point closest to the current position of the wheel loader comprise points located less than twice a length of the autonomous load-carrier vehicle from said closest point. Typically, “the immediate surroundings” is less than 10, or even 5, meters from the point closest to the current position of the wheel loader.

The invention also concerns a system for controlling movement of an autonomous load-carrier vehicle along a pre-set path, the system comprising:
a positioning sensor arranged onto a loader vehicle intended to be used for loading the autonomous load-carrier, wherein the positioning sensor is configured to provide a control signal indicative of a current position of the loader vehicle;
a control system configured to:
   handle the control signal provided by the positioning sensor arranged onto the loader vehicle;
   determine a point on the pre-set path that is closest to the current position of the wheel loader
   set a suitable loading position for the autonomous load-carrier vehicle along the pre-set path based on the point on the pre-set path that is closest to the current position of the wheel loader; wherein the suitable loading position corresponds to the point closest to the current position of the wheel loader or is a point in the immediate surroundings of said closest point that, when the autonomous load-carrier vehicle stops at the suitable loading position, allows pre-set aligning of a part of the autonomous load-carrier vehicle in relation to the loader vehicle when the loader vehicle is positioned close to the pre-set path; and
   control the autonomous load-carrier vehicle so as to move along the pre-set path and stop at the suitable loading position.

In an embodiment of the system, the control system is configured to carry out the various variants of the method described above.

### BRIEF DESCRIPTION OF THE DRAWINGS

With reference to the appended drawings, below follows a more detailed description of embodiments of the invention cited as examples.

In the Drawings:

FIG. 1 shows a schematic view of a system according to the present disclosure.

FIG. 2 shows a schematic view of an example method according to this disclosure.

### DETAILED DESCRIPTION OF EXAMPLE EMBODIMENTS OF THE INVENTION

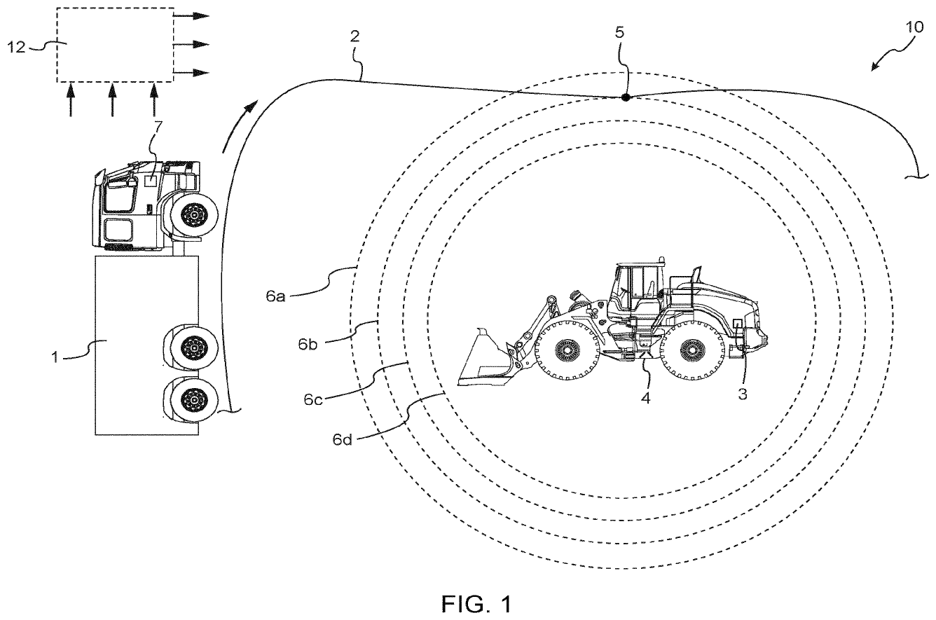

FIG. 1 shows a system 10 for controlling movement of an autonomous load-carrier vehicle 1 along a pre-set path 2 at a construction site. The pre-set path 2 forms in this example a loop allowing the autonomous load-carrier vehicle 1 to move along in the same direction. An unloading location (not shown) for unloading of the autonomous load-carrier vehicle 1 is arranged in association with the pre-set path 2.

The system 10 comprises a loader vehicle 4 intended to be used for loading the autonomous load-carrier vehicle 1 at a suitable loading position 5. The loader vehicle 4 is provided with a positioning sensor 3 configured to provide a control signal indicative of a current position of the loader vehicle 4. Also the autonomous load-carrier vehicle 1 is provided with a positioning sensor associated with a control circuitry 7 configured to communicate with the control system 12 and allowing the control system 12 to control e.g. the movements of the autonomous load-carrier vehicle 1 along the pre-set path 2.

The control system 12 is in this case configured to control the main method including:
handling of the control signal provided by the positioning sensor 3 arranged onto the loader vehicle 4;
determining a point on the pre-set path 2 that is closest to the current position of the loader vehicle 4;
setting a suitable loading position 5 for the autonomous load-carrier vehicle 1 at a point along the pre-set path 2 based on the point on the pre-set path 2 that is closest to the current position of the loader vehicle 4; wherein the suitable loading position 5 corresponds to the point closest to the current position of the loader vehicle 4 or is a point in the immediate surroundings of said closest point (as explained further below); and
controlling the autonomous load-carrier vehicle 1 so as to move along the pre-set path 2 and stop at the suitable loading position 5.

Arrows at the control system 12 indicates that the control system is configured to receive and send out various wire-less control signals.

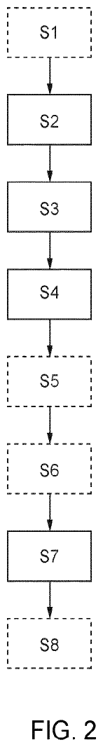

An example of the method for controlling movement of the autonomous load-carrier vehicle 1 along the pre-set path 2 at the construction site is indicated in FIG. 2 and comprises the following steps:
S1—providing a control signal indicative of a request for the autonomous load-carrier vehicle 1 to be loaded by the loader vehicle 4. This control signal may be sent from the loader vehicle 4 to the control system 12 as a result of an action by an operator of the loader vehicle 4.
S2—providing, from the positioning sensor 3 arranged onto the loader vehicle 4 intended to be used for loading the autonomous load-carrier vehicle 1, a control signal indicative of a current position of the loader vehicle 4.
S3—determining a point on the pre-set path 2 that is closest to the current position of the loader vehicle 4. This is typically done by the control system 12 that has access also to the positioning data forming the pre-set path 2.
S4—setting a suitable loading position 5 for the autonomous load-carrier vehicle 1 at a point along the pre-set path 2 based on the point on the pre-set path that is closest to the current position of the loader vehicle 4; wherein the suitable loading position 5 corresponds to the point closest to the current position of the loader vehicle (4) or is a point in the immediate surroundings of said closest point (as explained further below).
S5—repeating the steps S1, S2 and S4 so as to update the suitable loading position 5 when/if the loader vehicle 4 moves.
S6—locking the suitable loading position 5 for the autonomous load-carrier vehicle 1 so that it no longer follows the position of the loader vehicle 4.
S7—controlling the autonomous load-carrier vehicle 1 so as to move along the pre-set path 2 and stop at the suitable loading position 5.
S8—starting the autonomous load-carrier vehicle 1 after having been loaded by the loader vehicle 4 and moving the autonomous load-carrier vehicle 1 along the pre-set path 2 in the same direction as it moved before stopping at the suitable loading position 5. Typically, the autonomous load-carrier vehicle 1 is moved to an unloading location at another point along the pre-set path 2.

The step S3, i.e. the step of determining the point on the pre-set path 2 that is closest to the current position of the loader vehicle 4 may comprise:
S31—searching for points defining the pre-set path 2, wherein the search is carried out along a first circle 6a-6d around the loader vehicle 4;
S32—if no path-defining points are found along the first circle: searching for path-defining points along a second circle 6a-6d that is larger than the first circle;
S33—if a plurality of path-defining points are found along the first circle: searching for path-defining points along a third circle 6a-6d that is smaller than the first circle.

Different circles 6a-6b are indicated in FIG. 1. As an example, circle 6c may be “the first circle” used in S31. Since circle 6c does not intersect with the pre-set path 2 (i.e. no path-defining points are found along the first circle), a search according to S32 is done where the larger circle 6a may form the “second circle”. Circle 6a intersects with the pre-set path 2 at two points (i.e. a plurality of path-defining points are found along circle 6a). Circle 6a may now be considered to form “the first circle”. A search according to S33 is now conducted along circle 6b, which is smaller than circle 6a (and larger than circle 6c) and which now may be considered to form “the third circle” according to S33. Circle 6b intersects with the path 2 only at one point (depending on resolution, uncertainty intervals etc.), which corresponds to the point on the pre-set path 2 that is closest to the current position of the loader vehicle 4. The “closest point” has thus been determined and step S3 is finished.

It may be considered that the “closest point” has been determined when a circle intersects with the pre-set path 2 at two points that are separated by less than a certain threshold value, such as a few meters, or less than one meter if it is desired to set the suitable loading point very exactly. The “closest point” may be considered to be the point on the pre-set path 2 in the middle between the two intersecting points.

As described further above, it is not necessary that the suitable loading point corresponds exactly to the point on the pre-set path 2 that is closest to the current position of the loader vehicle 4. Depending on the exact location of the positioning sensors, the type and size of the autonomous load-carrier vehicle 1, etc., it may even be desired to position the autonomous load-carrier vehicle 1 a short distance away from the “closest point” so that the autonomous load-carrier vehicle 1 becomes positioned somewhat in front or behind of the loader vehicle 4 to simplify loading. That is, when the autonomous load-carrier vehicle 1 stops at the suitable loading position 5 it may be beneficial to make use of a pre-set alignment of a part of the autonomous load-carrier vehicle 1 in relation to the loader vehicle 4 when the loader vehicle 4 is positioned close to the pre-set path 2. This alignment is used only in “the immediate surroundings” of the point closest to the current position of the loader vehicle 4. These “immediate surroundings” comprise points located less than twice a length of the autonomous load-carrier vehicle 1 from said closest point.

It is to be understood that the present invention is not limited to the embodiments described above and illustrated in the drawings; rather, the skilled person will recognize that many changes and modifications may be made within the scope of the appended claims.

1. A method for controlling movement of an autonomous load-carrier vehicle along a pre-set path at a construction site, the method comprising:
providing, from a positioning sensor arranged onto a loader vehicle intended to be used for loading the autonomous load-carrier vehicle, a control signal indicative of a current position of the loader vehicle;
determining a point on the pre-set path that is closest to the current position of the loader vehicle;
setting a suitable loading position for the autonomous load-carrier vehicle at a point along the pre-set path based on the point on the pre-set path that is closest to the current position of the loader vehicle; wherein the suitable loading position corresponds to the point closest to the current position of the loader vehicle or is a point in the immediate surroundings of said closest point so as to, when the autonomous load-carrier vehicle stops at the suitable loading position, allow pre-set aligning of a part of the autonomous load-carrier vehicle in relation to the loader vehicle when the loader vehicle is positioned close to the pre-set path; and
controlling the autonomous load-carrier vehicle so as to move along the pre-set path and stop at the suitable loading position.

2. The method according to claim 1, wherein the step of determining the point on the pre-set path that is closest to the current position of the loader vehicle comprises:
searching for points defining the pre-set path, wherein the search is carried out along a first circle around the loader vehicle;
if no path-defining points are found along the first circle: searching for path-defining points along a second circle that is larger than the first circle;
if a plurality of path-defining points are found along the first circle: searching for path-defining points along a third circle that is smaller than the first circle.

3. The method according to claim 1, wherein the method comprises:
locking the suitable loading position for the autonomous load-carrier vehicle so that it no longer follows the position of the loader vehicle.

4. The method according to claim 1, wherein the method comprises:
starting the autonomous load-carrier vehicle after loading by the loader vehicle and moving the autonomous load-carrier vehicle along the pre-set path in the same direction as it moved before stopping at the suitable loading position.

5. The method according to claim 1, wherein the method comprises:
providing a control signal indicative of a request for the autonomous load-carrier vehicle to be loaded by the loader vehicle.

6. The method according to claim 1, wherein the method comprises:
repeating the steps of i) providing the control signal indicative of the current position of the loader vehicle, ii) determining the point closest to the current position of the wheel loader and iii) setting the suitable loading position for the autonomous load-carrier vehicle, so as to update the suitable loading position when the loader vehicle moves.

7. The method according to claim 1, wherein the immediate surroundings of the point closest to the current position of the loader vehicle comprise points located less than twice a length of the autonomous load-carrier vehicle from said closest point.

8. A system for controlling movement of an autonomous load-carrier vehicle along a pre-set path at a construction site, the system comprising:
a positioning sensor arranged onto a loader vehicle intended to be used for loading the autonomous load-carrier vehicle, wherein the positioning sensor is configured to provide a control signal indicative of a current position of the loader vehicle;
a control system configured to:
handle the control signal provided by the positioning sensor arranged onto the loader vehicle;
determine a point on the pre-set path that is closest to the current position of the loader vehicle;
set a suitable loading position for the autonomous load-carrier vehicle at a point along the pre-set path based on the point on the pre-set path that is closest to the current position of the loader vehicle; wherein the suitable loading position corresponds to the point closest to the current position of the loader vehicle or is a point in the immediate surroundings of said closest point that, when the autonomous load-carrier vehicle stops at the suitable loading position, allows pre-set aligning of a part of the autonomous load-carrier vehicle in relation to the loader vehicle when the loader vehicle is positioned close to the pre-set path; and
control the autonomous load-carrier vehicle so as to move along the pre-set path and stop at the suitable loading position.

9. The system according to claim 8, wherein the control system is configured to carry out the method of claim 1.
